(19) United States
(12) Patent Application Publication
(10) Pub. No.: US 2002/0149665 A1
(43) Pub. Date: Oct. 17, 2002

(54) Redundancy for individually addresable laser diode arrays based systems

(76) Inventor: Serge Steinblatt, Ra'anana (IL)

Correspondence Address: Eitan Pearl Latzer & Cohen-Zedek, One Crystal Park, Suite 210, 2011 Crystal Drive, Arlington, VA, 22202-3709, US

(21) Appl. No.: 10/069,471

(22) PCT Filed: Jun. 21, 2001
(86) PCT No.: PCT/IL01/00565

(51) Int. Cl. B41J 2/455

(52) U.S. Cl. 347/233

(57) ABSTRACT

Apparatus and process for mounting two individually addressable laser diode arrays so that the angle of the arrays can be changed without losing registration. The second array is used for redundancy and the angle changes serve for changing the imaging resolution. A non-rigid fixture is used to hold both arrays. When changing the angle of one of the arrays, causing it to rotate around a first center of rotation, the fixture deforms so as to rotate the second array around a second center of rotation by the same angle.

### CROSS-REFERENCES TO RELATED PATENT APPLICATIONS

This patent application claims priority from and is related to U.S. Provisional Patent Application Serial No. 60/216,018, filed Jul. 3, 2000, entitled: REDUNDANCY FOR INDIVIDUALLY-ADDRESSABLE LASER DIODE ARRAYS BASED SYSTEMS, this U.S. Provisional Patent Application incorporated by reference in its entirety herein.

### TECHNICAL FIELD

The present invention is directed to electronic imaging devices and in particular to imaging heads with individually addressable laser diode arrays (IALDA)

### BACKGROUND

In order to increase the speed of imaging of various electronics imaging devices, such as laser printers, multiple laser sources are sometimes used in parallel.

For example, separate lasers have been combined opto-mechanically to provide simultaneous imaging of information through each of the emitters, as disclosed in U.S. Pat. No. 5,812,179 (Pensavecchia, et al.).

While this was successful in some circumstances, this configuration was not suitable in situations where the light sources needed to be very close to each other, as disclosed in U.S. Pat. Nos. 4,801,950 (Frehling) and 5,168,288 (Baek, et al.). Here, individual, separate devices could not be brought close enough to each other, because of the size of their package. Optical fibers were then used to form a secondary array of sources that are closely packaged.

Monolithic emitting devices, comprising a number of emitters on the same substrate, are also used. These emitters are usually arranged in an array and can be operated independently, thus forming an individually addressable emitters array. This type of device, using LED, is commercially available and manufactured, for example, by AEG Telefunken, Germany. These LED arrays are highly reliable, as they operate at low emission power, under low current.

However, other applications, like thermal imaging, require orders of magnitude more light power than a LED array can provide. To provide the needed power, it was proposed to use laser diodes instead of the LEDs, building them into individually addressable laser diode arrays (IALDA).

This proposed solution had drawbacks. Initially, laser diodes have far shorter life-spans than LEDs and therefore a IALDA will have a far shorter life-span than a LED array.

Second, in imaging applications, it is essential that all the emitters of the array function properly. This means that if there is no redundancy at the level of the emitters, a IALDA will be considered to have failed as soon as one of its emitters fails. For high power IALDA, emitting power of the order of 0.5 Watt per emitter, the time for the first emitter to fail in an array can be as low as 500 hours.

In an attempt to address these drawbacks, a redundancy scheme was disclosed in U.S. Pat. No. 5,594,752 (Endriz). Here, multiple emitters contribute to the same light spot to be imaged. If one emitter fails, the other emitters contributing to the same imaged spot will be operated at increased power, to compensate for the power loss caused by the failure of the emitter.

FIGS. 1A, 1B, 2A and 2B, detail basic principles and limitations of the contemporary art. FIGS. 1A and 1B are directed to a single array, while FIGS. 2A and 2B are directed to dual arrays.

FIGS. 1A and 1B depict the principle of resolution change for an array of sources at a distance P₁ from each other, by changing the angle (α₁ and α₂) of the array 10 with respect to the scanning direction 20. The spacing of the imaged lines, represented by P₂, is proportional to the sine (sin) of the respective angles α₁, α₂ between the array of sources and the scanning direction.

Problems occur when this approach is applied to two arrays of sources. As shown in FIG. 2A two arrays 10, 15 are oriented at a given angle α with respect to the scanning direction 20, corresponding to a given resolution. The distance between the arrays, as measured along the scanning direction, is H, and the arrays 10, 15 are spaced apart at a distance T to be parallel. Both arrays are supposed to be parallel to each other and in registration, meaning that the source 1.1 of the first array and the source 2.1 of the second array are capable of imaging the line 1. If the spacing of the sources within the arrays is similar, which is easily achievable on monolithic devices, the source 1.5 on the first array and the source 2.5 on the second array will be capable of imaging the line 5. The same is true for all other lines, line 2-line 4, therebetween. It is also assumed that both arrays are mounted rigidly to a common fixture. This mounting is not shown here for simplicity reasons.

When the system needs to be operated at another resolution, attempts can be made to rotate the arrays, for example, by an angle β, corresponding to the new resolution, as shown in FIG. 2B. It shall be assumed that this rotation by the angle β is performed around the source 1.1. Due to this rotation, the trace 1 produced by the source 1.1 will not move. However, the source 2.1 will be shifted by a distance δ given by H·tan β. This source, if operated, will now give a trace 1′ that is not in registration with the trace 1 produced by the first array.

### SUMMARY

The present invention describes IALDA based imaging devices that have longer lives when compared to a single IADA imaging head, as the devices of a the present invention provide a redundancy of the emitters that will statistically increase the operation time of the imaging head. The present invention employs two arrays of sources, or two segments of an array of sources, that are used to provide the redundancy of the sources. The two arrays are mounted in perfect mechanical registration, so that two sources, one of each array, are capable of imaging the same line.

When all the sources are in operating condition, only the sources of the first array are in use. When one of the sources of this array fails, the corresponding source of the second array is operated, and the imaging head can continue to function.

From the statistical point of view, this source of the second array has a longer life-span than the source that failed in the first array. Thus, the life-span of the print head is increased by more than twice the statistical life-span of the source.

Further, a mechanical arrangement is proposed to overcome the problem of resolution change for two superposed arrays of sources.

The invention also provides a rotation mechanism that will leave the arrays in registration during rotation, over the resolution range that needs to be covered by the system.

There is also disclosed an imaging apparatus comprising, a first array comprising a plurality of individually addressable light sources, arranged at a first angle with respect to a scanning direction, this first array rotatable about a first (rotation) axis. There is also a second array comprising a plurality of individually addressable light sources, arranged at this first angle with respect to the scanning direction, this second array rotatable about a second (rotation) axis. The first (rotation) axis is at a location different than the second (rotation) axis. Each plurality of individually addressable light sources of the first array corresponds with one of the plurality of individually addressable light sources on the second array, to define pairs of light sources, and these pairs of light sources are configured for imaging the same line for any angle of rotation of the linear arrays around the respective first and second (rotation) axes.

There is also disclosed an imaging method comprising, providing a first linear array of individually addressable light sources, providing a second linear array of individually addressable light sources, providing a first rotation axis for rotating the first linear array; and providing a second rotation axis, different from the first rotation axis, for rotating the second linear array, A first rotation angle according to a desired imaging resolution is determined. The first linear array is rotated around the first rotation axis to create a second angle between the first array and a scanning direction, and the second linear array is also rotated around the second rotation axis to create this second angle between the second array and the scanning direction. This first linear array is used for imaging; and a corresponding respective light source from the second array is used for imaging whenever a light source from the first linear array fails.

### BRIEF DESCRIPTION OF THE DRAWINGS

Attention is now directed to the attached drawings, wherein like reference numerals or characters indicate corresponding or like components. In the drawings.

FIGS. 1A and 1B are diagrams of single arrays in accordance with the Prior Art;

FIGS. 2A and 2B are diagrams of dual arrays in accordance with the Prior Art;

FIG. 3 is a diagram of a dual array in accordance with the present invention;

FIG 4 is a diagram of a system including the apparatus of the present invention;

FIG. 5 is a diagram of an apparatus employing the present invention at a resolution;

FIG. 6 is a diagram of the apparatus of FIG. 5 in operation; and

FIGS. 7A-7C are a diagram of a process used to adjust the resolution in the apparatus of FIG. 5.

### DETAILED DESCRIPTION OF THE DRAWINGS

The present invention relates to apparatus and processes for mounting source arrays thereon, so that the angle of the arrays can be changed without loosing registration. The present invention utilizes a non-rigid fixture to hold both arrays. When modifying the angle of one of the arrays, causing the first array to rotate around a first center of rotation, the fixture deforms so as to rotate the second array around a second center of rotation by the same angle as the first array.

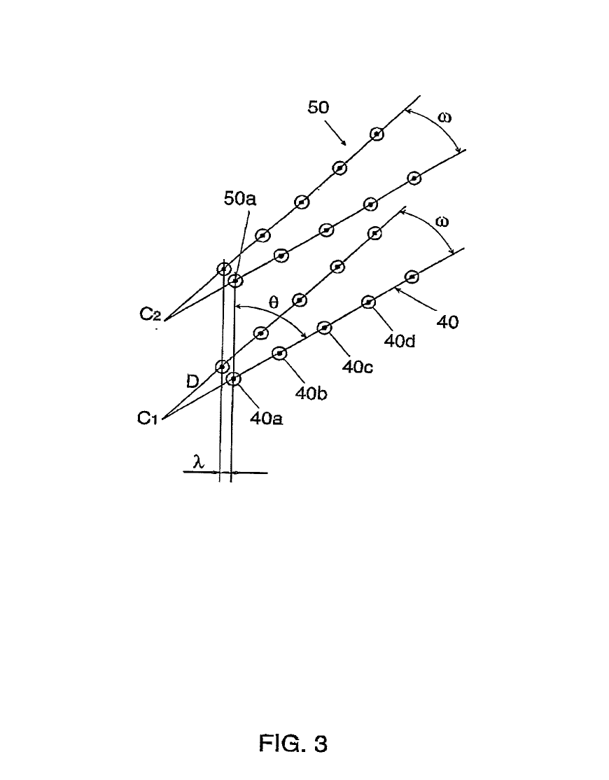

FIG. 3 is an exemplary illustration of the present invention. Here, there is a center of rotation C1 for the first array 40. It is aligned with the sources 40a-40d of the array, at a distance D from the first source 40a, but in practice it could be located at any other position. When the array 40 is rotated, the position of the line imaged by the first source 40a will be shifted by a distance λ, which is given by:

λ=D·(sin θ−sin(θ−ω))

where θ is the angle of the array with respect to the scanning direction before rotations and

ω is the angle of rotation for the array.

If C1 is not aligned with the sources array, this equation is slightly different, but the principle is similar. The differences are that the angle of offset from the respective axis is factored into the above equation.

The center of rotation C2 of the second array 50 is positioned at the same relative position to the second array as C1, relative to the first array 40. Then, the first source 50a of the second array will be shifted by the same amount λ and therefore, the lines imaged by the first sources 40a and 50a will be in registration for any angle ω. A similar development holds in fact for all the sources in the arrays, meaning that the two full arrays will stay in registration for any angle ω.

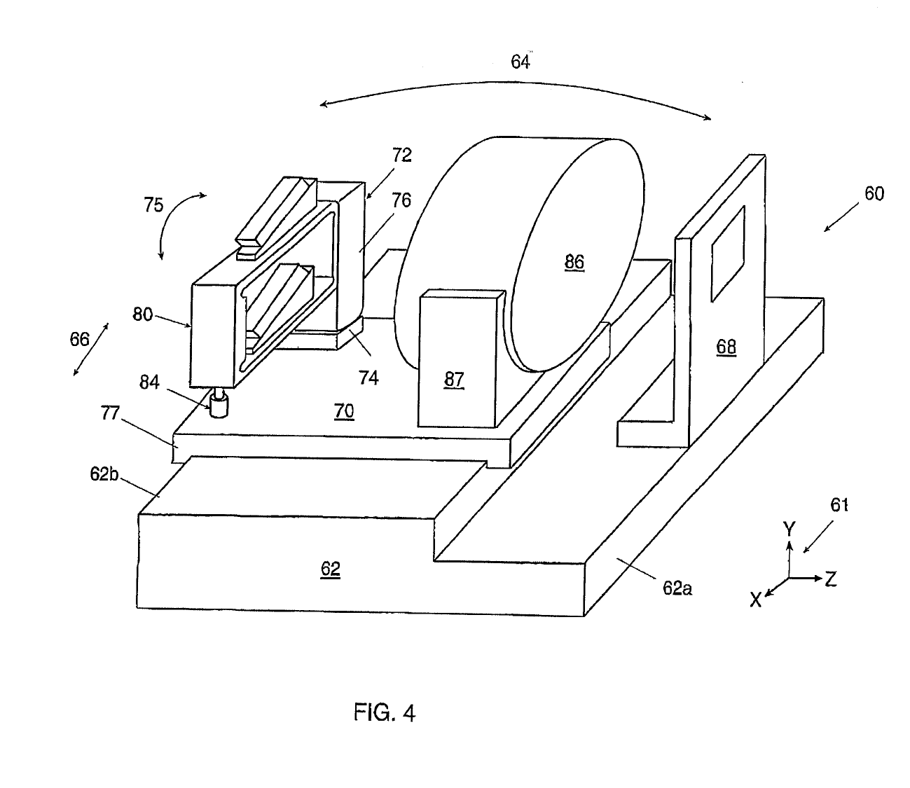

FIG. 4 shows an example system 60, employing the present invention. There is also a coordinate system 61, detailing the X, Y and Z axes and respective planes formed by these axes, for purposes of orientation and explanation of the system 60. The system 60 includes a base 62, with a lower portion 62a and an upper or guide portion 62b that slidably supports an imaging head 64, movable along the guide portion 62b in the direction of double headed arrow 66 (along the X axis as per the coordinate system 61). An X-Y detector 68, such as one capable of outputting signals that are proportional to the position of a light spot, is commercially available from UDT Sensors, Inc., Hawthorne, Calif., and is typically mounted to the lower portion 62a of base 62. This X-Y detector 68 is in alignment with an imaging drum that is not shown, but may be for example, in accordance with that detailed in U.S. Pat. No. 5,986,819 (Steinblatt), this patent incorporated by reference herein.

The imaging head 64 includes a platform 70, shaped to be slideably retained on the guide portion 62b of the base 62. A fixture 72 is pivotally mounted in a cup 74, such that the fixture can be rotated in the direction of the double-headed arrow 75. The fixture 72 is formed by a vertical portion 76 and a lateral portion 77, typically oriented perpendicular to each other.

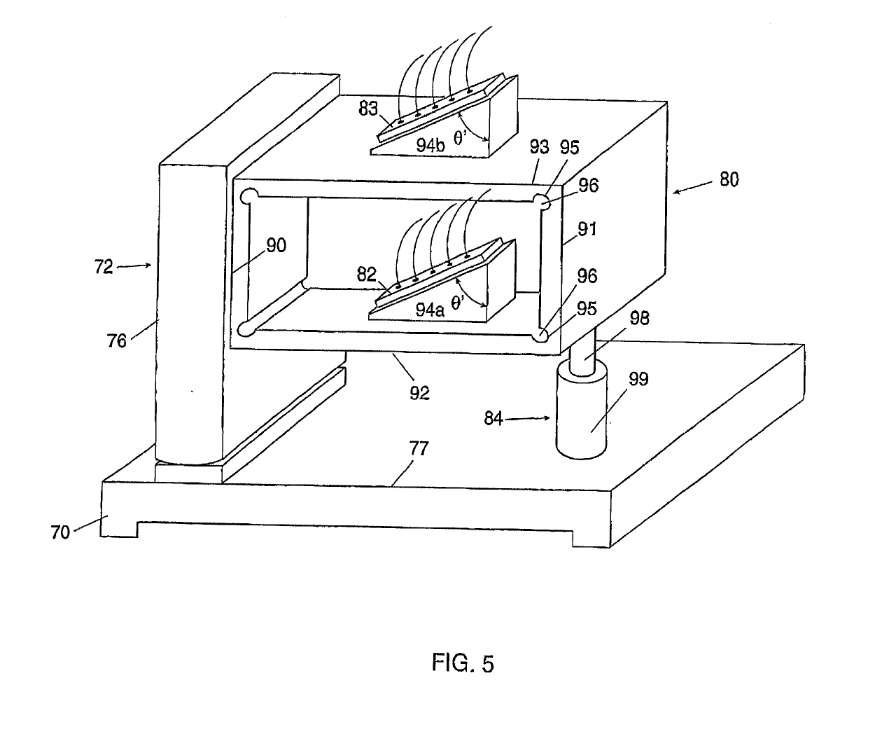

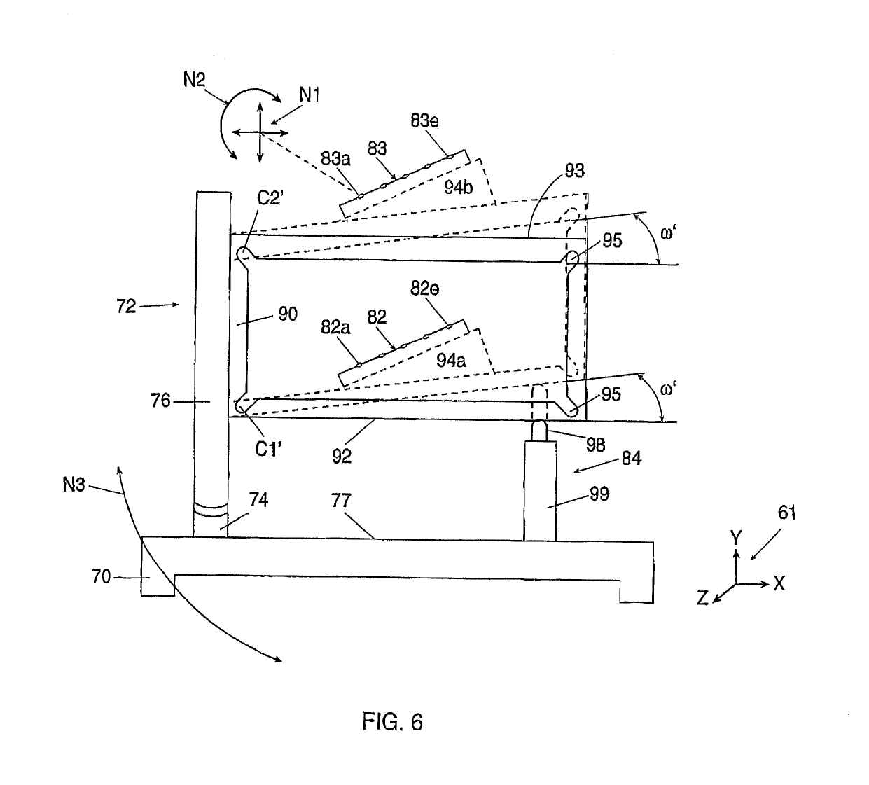

Turning also to FIGS. 5 and 6, a frame 80, supporting arrays of sources 82, 83 (with individual sources labeled 82a-82e for array 82 and 83a-83e for array 83) is attached to vertical portion 76 of the fixture 72, by any conventional attachment. An actuator 84, for moving the frame 80 (as detailed below) is connected to the lateral portion 77 of the fixture 72.

This pivotally mounted fixture 72 coupled with the actuator 84, provides an adjustment system for the source arrays 82, 83. Specifically, the cup 74 mounting of the fixture 72 allows for large or coarse adjustments of the source arrays 82, 83, while the actuator allows for small or fine adjustments of the source arrays, as detailed below. Moreover, the frame 80 is such that the center of rotation related to each array 82, 83 must be precisely located with respect to the specific array 82, 83. Depending on the required level of registration, this accuracy can either be obtained by mechanical tolerances, or may require adjustment.

An imaging lens 86 is held by a support 87, that is attached to the platform 70. The imaging lens 86 and arrays of sources 82, 83 are oriented with respect to each other on the system 60, so as to be aligned. The slidable imaging head 64 allows movement of the aligned source arrays 82, 83 and imaging lens 86 so as to be aligned with the X-Y detector 68 and imaging drum (not shown), for proper imaging on the imaging drum along an imaging plane (IP) (not shown).

The Imaging Plane (IP) is coincident with the photosensitive material wrapped around the drum. The X-Y detector 68 is positioned the same distance from the lens 86 as the imaging plane, and at the side of the drum, referred to as the “home” position. As a result, when the lens 86 is focused on the imaging plane while imaging, it will also be focused on the X-Y detector 68, while in the home position.

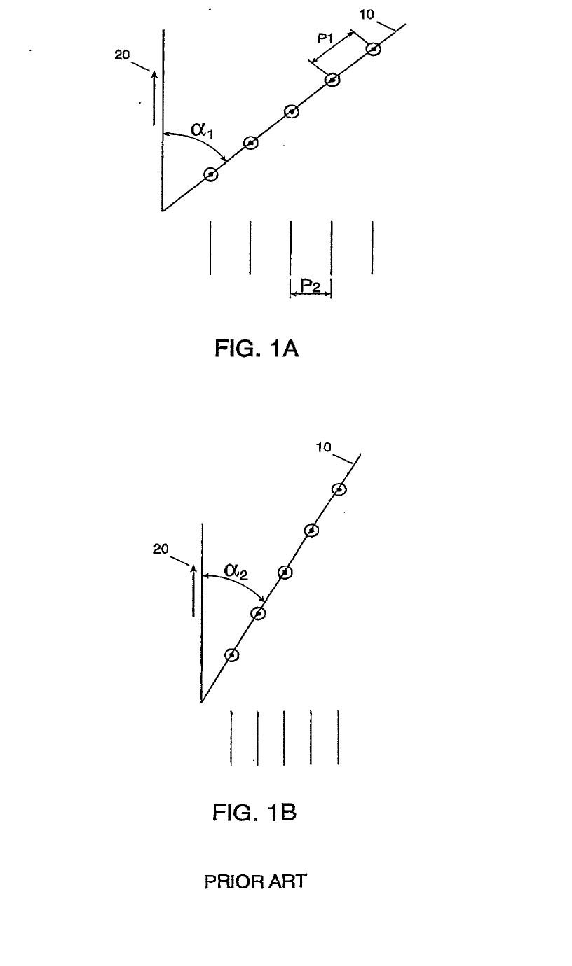

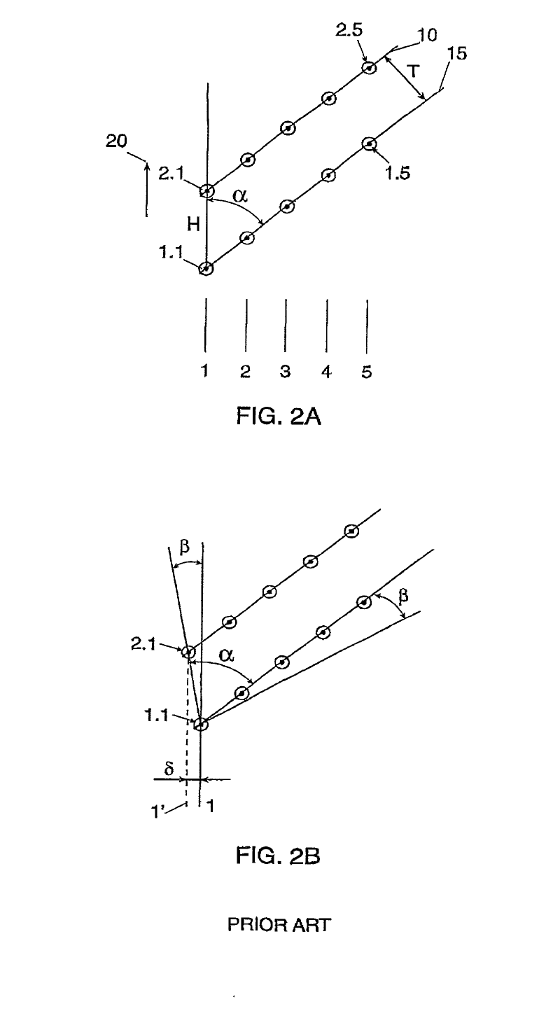

FIGS. 5 and 6 show the frame 80 and its operation in greater detail. The frame 80 is formed of rigid vertical side-walls 90, 91 and rigid horizontal walls 92, 93, on which the arrays of sources 82, 83 are mounted and arranged at an angle θ′, this angle θ′ typically measured with respect to the vertical, here the scanning direction (which is assumed to be vertical) on mounting ramps 94a, 94b. The angle θ in the example here, corresponds to angle θ in FIG. 3. It is selected such that the minimum achievable resolution Rₘᵢₙ, or maximum distance between the scan lines (distance between sources in the horizontal direction, analogous to P₂ in FIG. 1a), can be determined by the relation:

Rₘᵢₙ=M·P sin(θ′), where M is the magnification of the imaging lens 86 (FIG. 4), and P is the pitch between the individual sources (analogous to P₁ in FIG. 1a) For example, if the minimum required resolution is Rₘᵢₙ=20μ(50 lines/mm), for M=0.3 and P=300μ this angle will be θ′≈12.84°. One of the vertical side-walls, here for example side wall labeled 90 is attached to the vertical portion 76 of the fixture 72, by conventional attachments.

The frame 80 includes comer edges 95 with channels 96 therein. These channels 96 typically extend from end to end, and are of sufficient thinness to allow the frame 80 to elastically deform when moved by the actuator 84. Additionally, these channels 96 can be made thin enough to allow the frame to elastically deform over the desired ranges of resolutions necessary for proper imaging.

The frame 80 is made of a rigid material, such as metal, plastic or the like. When metal is used, it is preferred that the metal be aluminum. The frame 80 is typically formed from multiple pieces joined together by conventional joining techniques. The channels 96 are formed by weakening of the corner edges 95 of the frame 80. This typically requires that the thickness of the material in these regions be reduced, for example, as low as a few tenths of millimeters. For example, with an aluminum frame, this may be done by wire cutting techniques, such as electro-erosion. By creating the channels 96 in this manner, the frame 80 retains elastic properties over the desired deformation range.

The actuator 84 includes a stub 98, movable between a fully extended position and a fully retracted position, controlled by a motorized portion 99. This stub 98 contacts the lower horizontal wall 92 of the frame 80, and can be moved so as to raise and lower this horizontal wall 92, and thus, elastically deforming the frame 80.

FIG. 6 shows the deformation of the frame 80, between an initial position and a deformed position, shown in broken lines. In this figure, the arrays of sources 82, 83 are shown only in the position of the broken lines, for clarity.

When frame 80 movement is desired, the actuator 84 moves the stub 98, such that for example here, the lower horizontal wall 92 is formed upward. This movement deforms the frame 80 from a rectangular shape to a parallelogram shape, whereby the horizontal side-walls 92, 93, move in an unobstructed manner, in parallel to each other. Here, the corner edges 95 proximate the vertical side wall 90 attached to the vertical portion 76 of the fixture 70, serve as centers or axes of rotation (indicated by C1′ and C2′ respectively), allowing the horizontal walls 92, 93, supporting the respective source arrays 82, 83 to rotate at the same angle ω′ (with respect to the horizontal), and therefore rotating the respective source arrays 82, 83 at the same angle. This rotation at the same angle ω′ renders the source arrays 82, 83 operative to image the same line for any angle of rotation (about C1′ and C2′) sustained by the source arrays 82, 83, around their respective rotation axes. In this manner, each source array 82, 83 is redundant with respect to the other source array. Here, in this example, angle ω′ corresponds to angle ω of FIG. 3, but shown and described in an exemplary application. For example, angle ω′ can be a 90 degree rotation, ±45 degrees with respect to the horizontal, as constrained by the materials forming the frame 80.

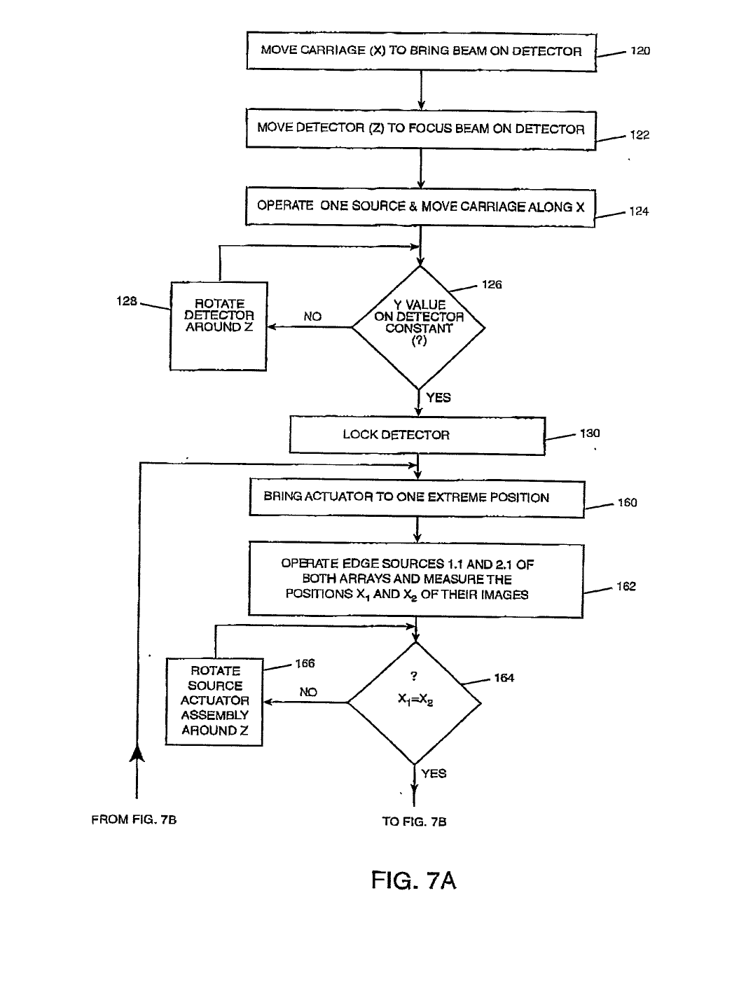

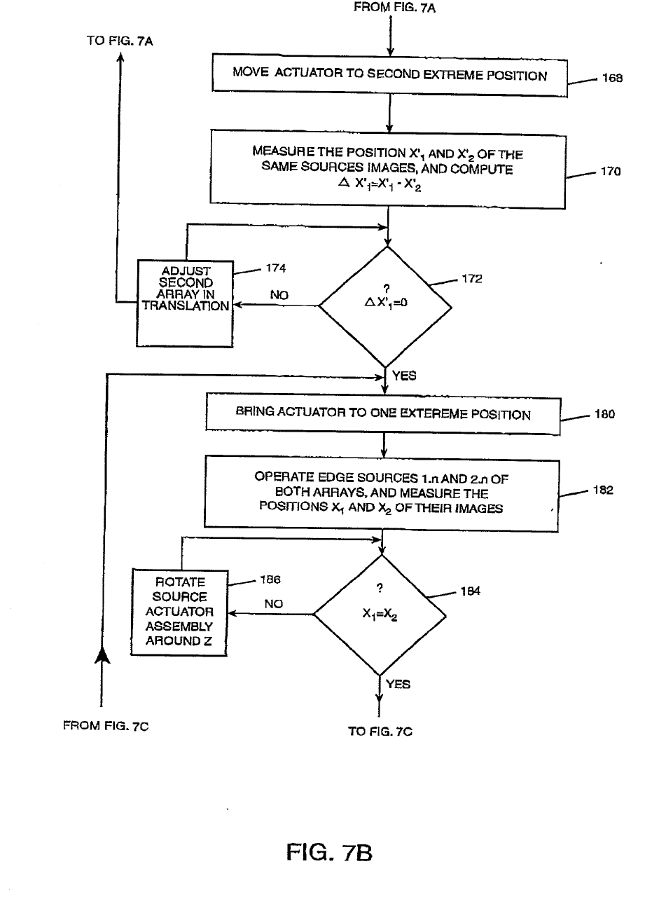

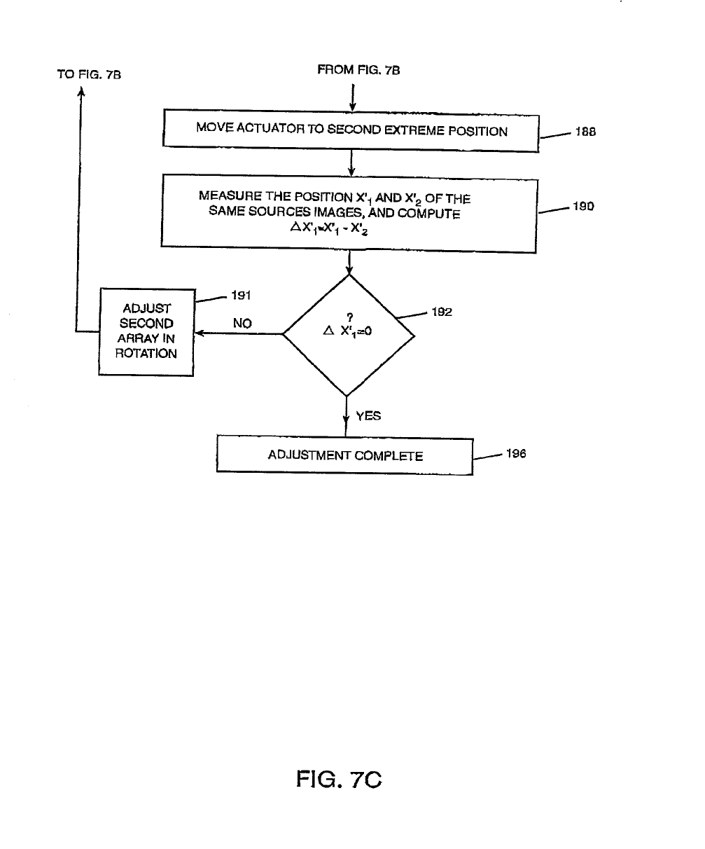

Turning now to FIGS. 7A-7C, operation of the present invention is now detailed by way of a flow diagram. This operation can be performed by hardware or combination of hardware and software, with machines such as computers, workstations and the like, in conjunction with, for example, the system 60, detailed above.

Initially, the platform 70 of the imaging head 64 is positioned along the X-axis (as per the coordinate system 61 of FIG. 4), so that light reaches the X-Y detector 68, at block 120. The X-Y detector 68 is adjusted into focus along the Z-axis (as per the coordinate system 61 of FIG. 4) at block 122, so as to be in the proximity of the image plane (IP) of the system 60.

Next, one of the source arrays 82, 83 is operated, while the carriage is moved along the guide beam direction, at block 124, in order to align the detector with the test guide beam.

In block 126, the signal Y is monitored to assure that it remains constant while the carriage is moving. If this is not the case, the X-Y detector 68 is rotated around the Z-axis at block 128, typically by a mechanical adjustment mechanism (not shown) and the procedure returns to the step of block 126. If the monitored Y value is constant, the X-Y detector 68 is locked, at block 130.

Next, the two arrays of sources need to be positioned so that their sources are in registration at all positions of the actuator 68 over the adjustment range. The adjustment is made by four mechanical positioning means that provide the necessary degrees of freedom. One is a rotation degree of the arrays-actuators assembly around the Z-axis.

Assuming the lower array of sources 82a-82e is fixed, the three additional degrees of adjustment are provided for the second array of sources (not shown). Two of these three degrees of adjustment allow the first source 83a to move in the XY plane, as per the coordinate system 61 of FIG. 6, in the directions labeled by the arrow N1 (FIG. 6), and the third one allows for rotation of the array 83 in this same plane around its first source 83a, as shown by curved arrow N2 (FIG. 6).

The adjustment procedure then continues at block 160, where the actuator 84 is brought to one of the extreme positions (the stub 98 is either fully extended or fully retracted), so as to detect the position of the image of one of the edge emitters, for example edge emitter 83e.

The source arrays 82, 83 are then operated alternatively, and the X positions X₁ and X₂ of their respective images on the detector are analyzed at block 162. Positions X₁ and X₂ are then compared, at block 164. If they are not equal, namely ΔX₁=X₁−X₂≠0, the whole sources-actuator assembly is rotated around the Z-axis (arrow N3 in FIG. 6), at block 166, and the process returns to block 164.

If positions X₁ and X₂ are equal, the actuator 84 is then moved to its second extreme position, at block 168. The X positions X′₁ and X′₂ of the images of the same sources are measured and the difference ΔX′₁=X′₁−X′₂ is computed, at block 170.

The value for ΔX′₁ is compared to zero, at block 172. If it is not zero, the position of the second source array, here source array 83 is adjusted by a translation along the X axis, at block 174, and the process returns to block 160 (where the above detailed process, of blocks 160-172 is repeated).

Depending on the chosen mechanical arrangement, the process of blocks to 160-174 is necessary for both translation degrees of freedom of the second source array, here the source array 83.

When ΔX₁ and ΔX′₁ are found to be zero, the source of the first source array, here source 82a of source array 82, and the corresponding source of the second array, here source 83a, are at identical positions with respect to the corresponding centers of rotation C1′ and C2′ (FIG. 6), and the process continues.

The extreme sources, source 82e of the first source array, here, source array 82, and source 83e of the second array, here, source 83, are now adjusted so they are also at identical positions with respect to the corresponding centers of rotation C1′ and C2′. For this, a procedure including the steps of blocks 180-194 is employed. The steps of blocks 180-194 are similar to corresponding blocks 160-174, respectively, and described above. Each step of blocks 160-174 is increased by “20” for the corresponding step of blocks 180-194. The only difference between these two series of blocks (160-174 and 180-194), is that the second source array, here source army 83 is adjusted in translation at block 174, and that in corresponding block 194, the second source array, here, source array 83, is adjusted in rotation along the Z-axis, with source 83a the center of rotation (as indicated by double headed curved arrow N2 in FIG. 6). The mechanical arrangement that rotates the second source array 83 needs to be such that the axis of rotation (parallel to Z-axis) substantially passes through source 83a, in order not to alter the adjustment achieved in the steps detailed in blocks 160-174. If ΔX′₁ is found equal to zero, the extreme sources, here sources 82e and 83e, respectively, are at identical positions with respect to the corresponding centers of rotation C1′ and C2′. Accordingly, the adjustment process is now complete at block 196.

The methods and apparatus disclosed herein have been described with exemplary reference to specific hardware and/or software. The methods have been described as exemplary, whereby specific steps and their order can be omitted and/or changed by persons of ordinary skill in the art to reduce embodiments of the present invention to practice without undue experimentation. The methods and apparatus have been described in a manner sufficient to enable persons of ordinary skill in the art to readily adapt other commercially available hardware and software as may be needed to reduce any of the embodiments of the present invention to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

1. An imaging apparatus comprising:
a first array comprising a plurality of individually addressable light sources, arranged at a first angle with respect to a scanning direction, said first array rotatable about a first axis;
a second array comprising a plurality of individually addressable light sources, arranged at said first angle with respect to said scanning direction, said second array rotatable about a second axis;
said first axis at a location different than said second axis;
each of said plurality of individually addressable light sources of said first array corresponding with one of said plurality of said individually addressable light sources of said second array, to define pairs of light sources, each of said pairs of light sources configured for imaging the same line for any angle of rotation of said linear arrays around said respective first and second axes.

2. The apparatus of claim 1, wherein said individually addressable light sources of said first and second array are arranged linearly with respect to each other.

3. The apparatus of claim 1, wherein said first angle is approximately 12 degrees.

4. The apparatus of claim 2, additionally comprising a frame, said frame including oppositely disposed first and second horizontal and first and second vertical walls, said horizontal and vertical walls connected at corners, said corners configured to allow said frame to be elastically deformable;
said first array mounted along said first horizontal wall and said second array mounted along said second horizontal wall; and
said first rotation axis and said second rotation axis at each of said respective corners defined by the intersections of said first vertical wall with said first and second horizontal walls.

5. The apparatus of claim 4, additionally comprising at least one vertical member and at least one lateral arm, said at least one vertical member connected to said first vertical wall, and said at least one lateral arm supporting an actuator, in communication with said second horizontal wall, said actuator for rotating said first and second arrays about said first and second axes respectively.

6. The apparatus of claim 5, wherein said frame is adapted for movement, by rotations of said first and second horizontal walls about said respective first and second axes at angles from approximately −45 degrees to +45 degrees with respect to the horizontal.

7. An imaging method comprising:
providing a first linear array of individually addressable light sources;
providing a second linear array of individually addressable light sources;
providing a first rotation axis for rotating said first linear array; and
providing a second rotation axis, different from said first rotation axis, for rotating said second linear array,
determining a first rotation angle according to a desired imaging resolution;
rotating said first linear array around said first rotation axis to create a second angle between said first array and a scanning direction;
rotating said second linear array around said second rotation axis to create said second angle between said second array and said scanning direction;
using said first linear array for imaging; and
using a respective light source from said second linear array for imaging, whenever a light source from said first linear array fails.
